(19) United States
(12) Patent Application Publication
(10) Pub. No.: US 2014/0086007 A1
(43) Pub. Date: Mar. 27, 2014

(54) Highly- efficient continuous stirrer

(71) Applicant: Zerong Li, Foshan (CN)

(72) Inventor: Zerong Li, Foshan (CN)

(21) Appl. No.: 13/980,871

(22) PCT Filed: Jul. 19, 2011
(86) PCT No.: PCT/CN11/01182

§ 371 Date: Sep. 27, 2013

(30) Foreign Application Priority Data
Jan. 24, 2011 (CN) 201110025690.2

(51) Int. Cl. B01F 7/00

(52) U.S. Cl. CPC B01F 7/005
USPC 366/302

(57) ABSTRACT

Disclosed in the present invention is a continuous stirrer, which comprises a receiving chamber provided with a front material inlet, a back material inlet and multilayer outer stirring needle groups along axial direction and a stirring shaft installed in the receiving chamber in a sealing manner and provided with multiple inner stirring needle groups along axial direction. The outer stirring needle groups and the inner stirring needle groups are staggered along axial direction, wherein inner stirring needles constituting the inner stirring needle groups and outer stirring needles constituting the outer stirring needle groups are arc or curve.

### TECHNICAL FIELD OF THE INVENTION

The invention relates to a stirring device.

1. Technical Background of the Invention

As disclosed in patent No.02272022.7, a highly-efficient continuous stirrer in the prior art generally consists of a cavity with a plurality of concave stirring pins, a front inlet and a back outlet, as well as a rotational shaft which has a plurality of rows of convex stirring pins and is provided in the cavity. The pins of the cavity and rotational shaft are staggered and provided. When in use, the fluid feed needed to be stirred is entered through the front inlet, is stirred by the pins continuously and goes out through the back outlet, thereby realizing a continuous stirred objective. If the feed is stirred with the moving and staggered pins, the stirring effect of the stirrer may be obviously improved. The stirring pin of the highly-efficient continuous stirrer is in the right-cylinder shape, and its stirred surface is determined by the highness and thickness of the stirring pin. If the stirred area is needed to be increased, the number of the stirring pins shall be needed to be increased. However, the increase of the number of the stirring pins is limited by the strength of the stirring pins, and the increase may not be infinite, thus limiting the increase of the stirring effect.

2. Summary of the Invention

The objective of the invention is to provide a highly-efficient continuous stirrer which may effectively increase the stirring effect.

The objective of the invention is realized as follows: the stirrer comprises a cavity which has a front feed inlet, a back feed outlet and a plurality of layers of outer stirring pin groups in the axial direction, as well as a stirring shaft which is sealed and provided in the cavity and has a plurality of layers of inner stirring pin groups in the axial direction, wherein the outer stirring pin group and the inner stirring pin group are axially staggered and provided. The stirrer is characterized in that the inner stirring pins constituting the inner stirring pin group and the outer stirring pins constituting the outer stirring pin group are in arc shape or curve shape. As the stirring pin is in arc shape or curve shape, in the same highness, the area of the stirring pin is larger than that of the right-cylinder stirring pin in the prior art, thus having high stirring efficiency. Furthermore, if an arc surface or a curve line is adopted, the force applied on the stirring pin by the stirred feed is transferred in the upper and the lower directions, thus reducing the force applied directly on the stirring pin by the feed. In the case that the strength is enough to resist the force applied by the feed, if the size of the stirring pin may be reduced, more stirring pins may be contained if there are the same volumes, thus effectively increasing the number of the stirring pins and the stirring efficiency.

Here, the arc-shaped curve direction or the curve-shaped curve direction of the inner stirring pins constituting the inner stirring pin group and that of the outer stirring pins constituting the outer stirring pin group are the same. If the curve direction of the arc surface or the curve line of the inner stirring pin and the curve direction of the arc surface or the curve line of the outer stirring pin are the same, when stirred, the direction of the force of the feed applied by the inner stirring pin and the direction of the force applied by the outer stirring pin are just opposite, thus being in favor of the mixture of the feed by itself and the mixture of the feed and the gases.

In order that convenient installation and use may be obtained, the inner stirring pins constituting the inner stirring pin group and the outer stirring pins constituting the outer stirring pin group have same or similar arc shapes or have same or similar curve shapes.

Compared with the prior art, the invention adopts arc-shaped or curve-shaped inner stirring pin and arc-shaped or curve-shaped outer stirring pin, thus having the advantage of effectively increased stirring effect.

### DRAWINGS OF THE INVENTION

FIG. 1 is a structural schematic diagram of the invention;

FIG. 2 is an A-A sectional view of FIG. 1;

FIG. 3 is a structural schematic diagram of a stirring shaft;

FIG. 4 is a structural schematic diagram of a cavity; and

FIG. 5 is a structural schematic diagram of a curve-shaped stirring pin.

### EMBODIMENTS OF THE INVENTION

With the combination of the drawings and embodiments, the invention is further described in details:

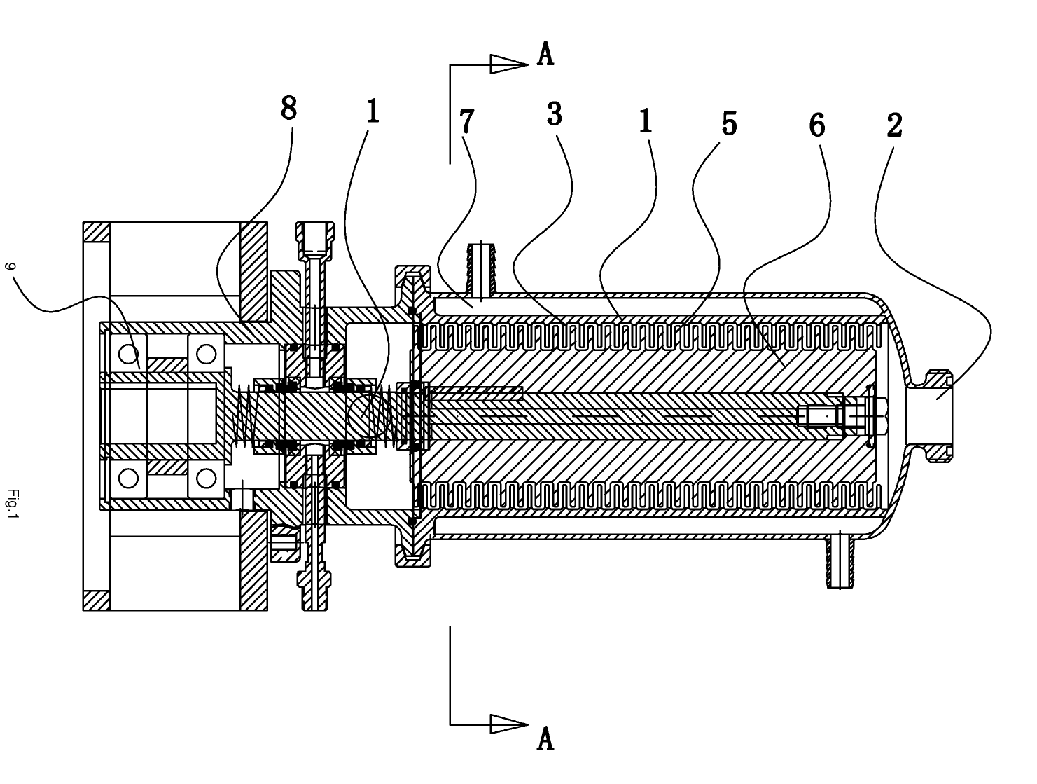

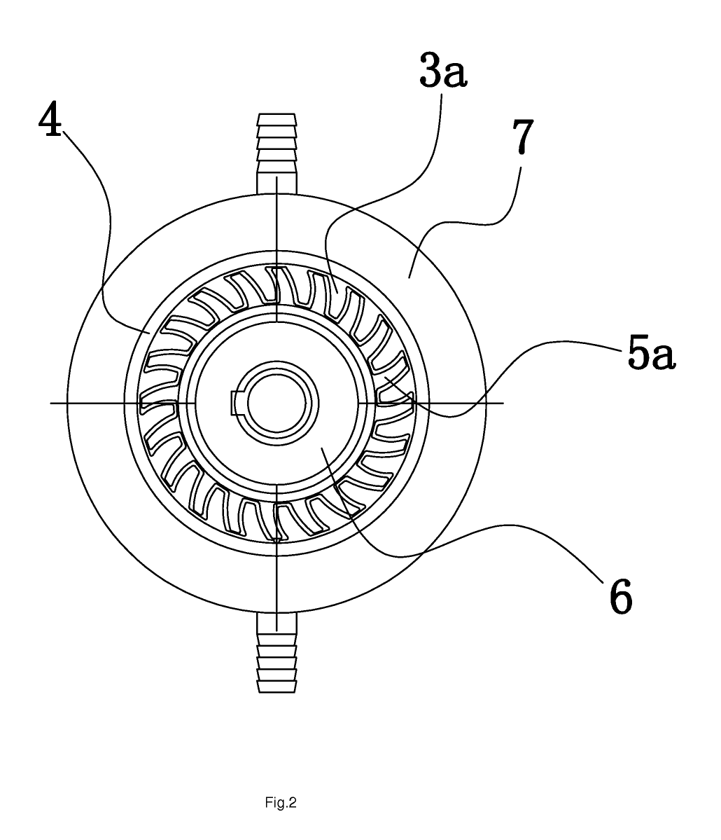

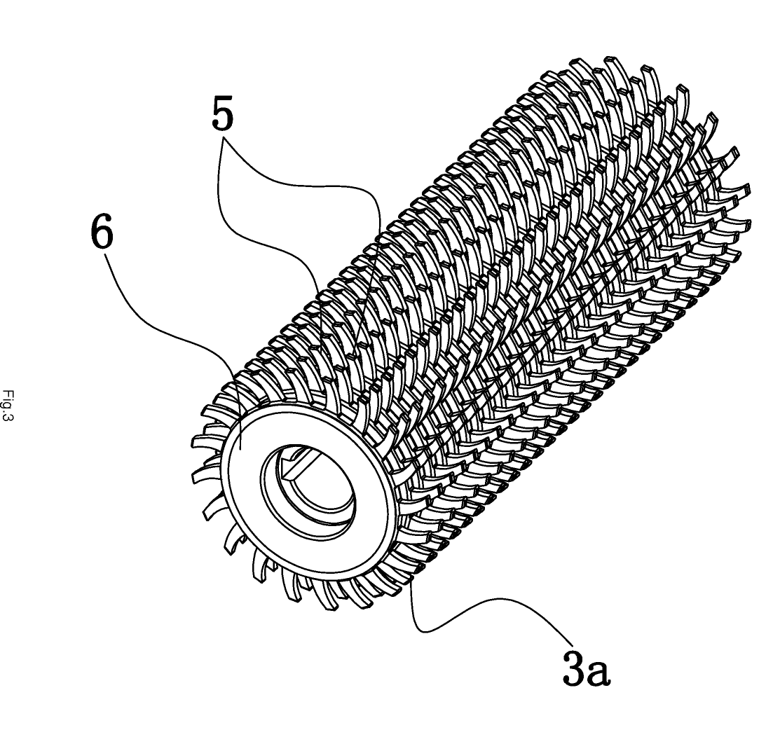

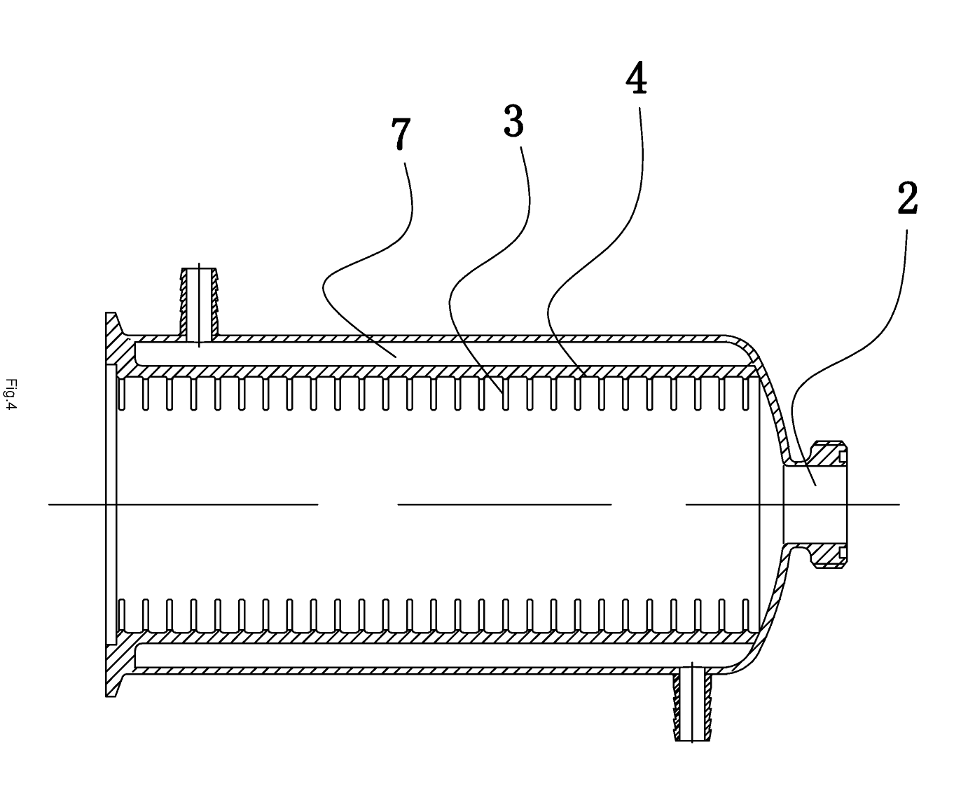

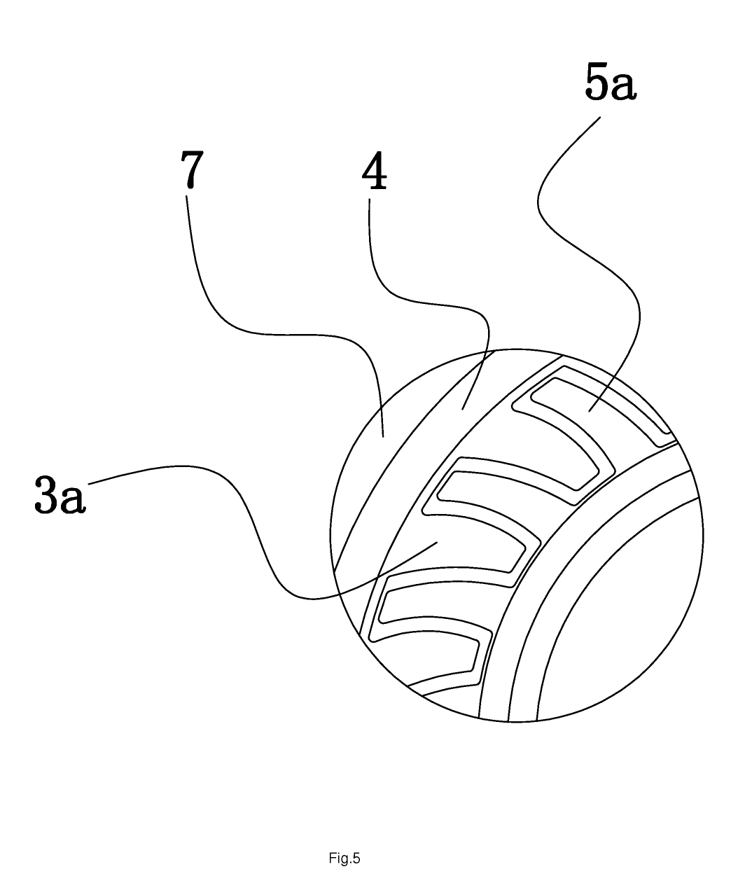

As shown in FIGS. 1, 2, 3, 4 and 5, the invention comprises a cavity 4 which has a front feed inlet 1, a back feed outlet 2 and a plurality of layers of outer stirring pin groups 3 in the axial direction, as well as a stirring shaft 6 which is sealed and provided in the cavity 4 and has a plurality of layers of an inner stirring pin groups 5 in the axial direction. A sandwich layer 7 is provided on the cavity 4. The outer stirring pin group 3 and the inner stirring pin group 5 are axially staggered and provided. The stirrer is characterized in that the inner stirring pins constituting the inner stirring pin group and the outer stirring pins constituting the outer stirring pin group are in arc shape or curve shape (as shown in FIG. 5).The materials of the outer stirring pin group 3 and the cavity 4 are stainless steel. The materials of the outer stirring pin group 5 and the cavity 6 are stainless steel. One side of the cavity 4 is connected with a bearing pedestal 9 with a sealed component 8. The stirring shaft 6 is passed through the sealed component 8 and connected on the bearing pedestal 9. The sealed component 8 is used to seal and separate the cavity 4 and the bearing pedestal 9. Therefore, rotation driving force is guaranteed to be provided for the stirring shaft 6 through external driving force while preventing the feed of the cavity 4 from being passed to the bearing pedestal 9.

In order that the stirrer may be manufactured conveniently, the front and the back sides of the inner stirring pins 5a constituting the inner stirring pin group 5 and those of the outer stirring pins 3a constituting the outer stirring pin group 3 are flat surfaces and their left and right sides are in arc shape or curve shape.

In order that the contact surface between the side of the stirring pin and the stirred substance is expanded, the shape of the side of inner stirring pin 5a and that of the outer stirring pin 3a are constituted with more than two smooth-transition concave-convex curve surfaces.

The arc-shaped curve direction or the curve-shaped curve direction of the inner stirring pins constituting the inner stirring pin group and that of the outer stirring pins constituting the outer stirring pin group are the same.

The inner stirring pins 5a constituting the inner stirring pin group 5 and the outer stirring pins constituting the outer stirring pin group 3 have the same or similar arc shape or have the same or similar curve shape.

1. A highly-efficient continuous stirrer, including a capacity which has a front feed inlet, a back feed outlet and a plurality of layers of outer stirring pin groups in the axial direction, as well as a stirring shaft which is sealed and provided in the capacity and has a plurality of layers of inner stirring pin groups in the axial direction, wherein the outer stirring pin group and the inner stirring pin group are axially staggered and provided. The stirrer is characterized in that inner stirring pins constituting the inner stirring pin group and outer stirring pins constituting the outer stirring pin group are all in arc shape or curve shape.

2. The highly-efficient continuous stirrer according to claim 1, wherein the front and the back sides of the inner stirring pins constituting the inner stirring pin group and those of the outer stirring pins constituting the outer stirring pin group are flat surfaces, and the right and the left sides thereof are arc shape or curve shape.

3. The highly-efficient continuous stirrer according to claim 1 or 2, wherein more than two of smooth-transition convex-concave surfaces constitute the shapes of the sides of the inner stirring pin and the outer stirring pin.

4. The highly-efficient continuous stirrer according to claim 1 or 2, wherein the arc-shaped curve direction or the curve-shaped curve direction of the inner stirring pins constituting the inner stirring pin group and that of the outer stirring pins constituting the outer stirring pin group are the same.

5. The highly-efficient continuous stirrer according to claim 3, wherein the arc-shaped curve direction or the curve-shaped curve direction of the inner stirring pins constituting the inner stirring pin group and that of the outer stirring pins constituting the outer stirring pin group are the same.

6. The highly-efficient continuous stirrer according to claim 1, 2 or 5, wherein the inner stirring pins constituting the inner stirring pin group and the outer stirring pins constituting the outer stirring pin group have the same or similar arc shape or the same or similar curve shape.

7. The highly-efficient continuous stirrer according to claim 3, wherein the inner stirring pins constituting the inner stirring pin group and the outer stirring pins constituting the outer stirring pin group have the same or similar arc shape or the same or similar curve shape.

8. The highly-efficient continuous stirrer according to claim 4, wherein the inner stirring pins constituting the inner stirring pin group and the outer stirring pins constituting the outer stirring pin group have the same or similar arc shape or the same or similar curve shape.
